(19) United States
(12) Patent Application Publication
(10) Pub. No.: US 2003/0101653 A1
(43) Pub. Date: Jun. 5, 2003

(54) SHUTTER WITH LOUVERS PIVOTED BY SLOTTED PIVOT BAR EXTENDING ALONG AN END OF THE LOUVERS

(76) Inventor: Walter Biro, Boca Raton, FL (US)

Correspondence Address: RONALD V. DAVIDGE, SUITE 514, 3300 UNIVERSITY DRIVE, CORAL SPRINGS, FL, 33065, US

(21) Appl. No.: 10/011,903

(22) Filed: Dec. 5, 2001

(51) Int. Cl. E06B 7/08

(52) U.S. Cl. 49/74.1

(57) ABSTRACT

A shutter includes a number of louvers mounted to pivot together, with each louver pivotally mounted by a pair of axle pins extending into adjacent side frame members of the shutter. A pivot bar extends between one of the side frame members and adjacent ends of the louvers, with axle pins extending through arcuate slots within the pivot bar around holes through which crank pins extend.

### BACKGROUND OF THE INVENTION

1. Field of the Invention

This invention relates to shutters, and, more particularly, to mechanisms for causing louvers within a group of louvers in a shutter to pivot simultaneously.

2. Summary of the Background Information

Shutters, in the form of window accessories or shutter doors, generally have either louvers that are stationary or louvers that are arranged to pivot when a pivot bar attached to an edge of each louver at its longitudinal center is raised or lowered, either by directly moving the pivot bar or by moving one of the louvers so that the remaining louvers move with it. When a louver is movable, it is individually pivoted by pins at the center of each of its ends. This conventional type of pivoting configuration has a disadvantage arising from the fact that it is difficult to arrange a satisfactory pivot in the center of the edge of each louver. If both the louvers and the pivot bar are formed of a solid material, such as wood, the pivoting arrangement is typically made up of a staple driven into one element while extending through an eyehook driven into the other element. This leaves the pivot bar loosely connected to the louvers. The application of pivot hooks to hollow plastic louvers and a hollow plastic pivot rod for mounting the pivot rod in the center of an edge of each of the louvers is shown in U.S. Pat. No. 5,303,507. Alternative methods for providing pivots along the edge of hollow plastic louvers are described in U.S. Pat. Nos. 5,187,896 and 5,778,598.

Regardless of the method chosen for pivotally attaching the pivot bar to each of the louvers at its center, this conventional type of attachment presents the pivot bar as a significant visual element directly in the middle of the shutter. In many instances, this result is often aesthetically unpleasing, interfering with the clean lines of the louvers and of the frame surrounding them, and appearing out of place if loose connections allow misalignment. Thus, what is needed for improved aesthetic considerations s a method for moving the pivot bar away from the center of the shutter and for, at least partially, hiding or disguising it, as described, for example, by U.S. Pat. No. 4,936,048 in the form of a shutter having a pivot bar attached to of each of the louvers at one of its ends, near its outer edge, by a nail extending through a hole in the pivot bar into the wooden louver. The nail may be driven at an acute angle to move the pivot hole closer to the edge of the louver without splitting the wood. A problem associated with this type of pivot bar arises from the fact that its cross-sectional size is limited. To allow the louvers to be fully closed, the pivot bar must not extend inward past the pivot pins centrally located in each of the louvers, when the louvers are closed, moving the pivot bar inward. However, it is aesthetically undesirable to extend the pivot bar significantly outward, past the ends of the louvers. These limitations on the cross-sectional size of the pivot bar make it difficult to make a pivot bar that is strong and stiff enough to overcome the frictional resistance that can be encountered in simultaneously pivoting a number of louvers, unless special provisions are made for controlling friction at the pivots.

U.S. Pat. No. 6,219,970 also describes a shutter having a pivot bar attached to an end of each louver near its front edge. In this shutter assembly, the corner of each louver at which the pivot bar is attached is recessed so that the remaining portion of the louver can extend to close a gap between the louver and an adjacent frame member. While this configuration proceeds further in a direction of hiding or disguising the pivot bar, even greater restrictions are placed on the shape of the pivot bar, with the pivot points being offset inward from the web extending between pivot points, so that the web can extend outside the louvers as they are closed.

U.S. Pat. No. 4,996,793 describes an indoor shutter in which the pivot rod is completely hidden within a box-like structure of a side frame member, being pivotally attached to a crank arm extending from an end of a pivot pin portion of each louver. Disadvantages of this configuration arise from the fact that a side frame member which is much larger that the side frame members of many shutters, and from the fact that the method for pivotally supporting the louvers is complicated by the provisions made for the crank arms.

Thus, what is needed is a simple yet rigid means for connecting a number of louvers to pivot together while eliminating a need for a pivot rod centrally disposed within the louvers.

### SUMMARY OF THE INVENTION

According to a first aspect of the invention, a shutter is provided, including a frame, a number of first pivot axle pins, a number of second pivot axle pins, a number of louvers, and a pivot bar. The frame includes an upper frame member, a lower frame member, and first and second side frame members. Each louver in the number of louvers is pivotally mounted to extend between the first and second side frame members by a first pivot axle pin within the number of first axle pins, extending between the first side frame member and a first end of the louver, adjacent the first side frame, and by a second pivot axle pin within the number of second axle pins, extending between the second side frame member and a second end of the louver, opposite the first end of the louver. The pivot bar, which includes a number of slots extending within the pivot bar, extends between the first side frame member and the first end of each the louver. The pivot bar is pivotally mounted to each louver within the number of louvers at a crank position offset through a first distance along the first end of the louver from the first pivot axle pin extending between the first side frame member and the first end of the louver. Each first pivot axle pin in the number of first pivot axle pins extends through a slot within the number of slots.

### BRIEF DESCRIPTION OF THE FIGURES

FIG. 1 is a front elevation of a shutter built in accordance with the invention;

FIG. 2 is a plan view of the shutter of FIG. 1;

FIG. 3 is left elevation of a louver assembly within the shutter of FIG. 1;

FIG. 4 is a front elevation of the louver assembly of FIG. 3;

FIG. 5 is a right elevation of the louver assembly of FIG. 3;

FIG. 6 is a fragmentary cross-sectional plan view of the shutter of FIG. 1, taken as indicated by section lines VI-VI therein;

FIG. 7 is a fragmentary cross-sectional right elevation of the shutter of FIG. 1, taken as indicated by section lines VII-VII therein; and

FIG. 8 is a front elevation of an alternative shutter, including two louver assemblies.

### DETAILED DESCRIPTION OF THE INVENTION

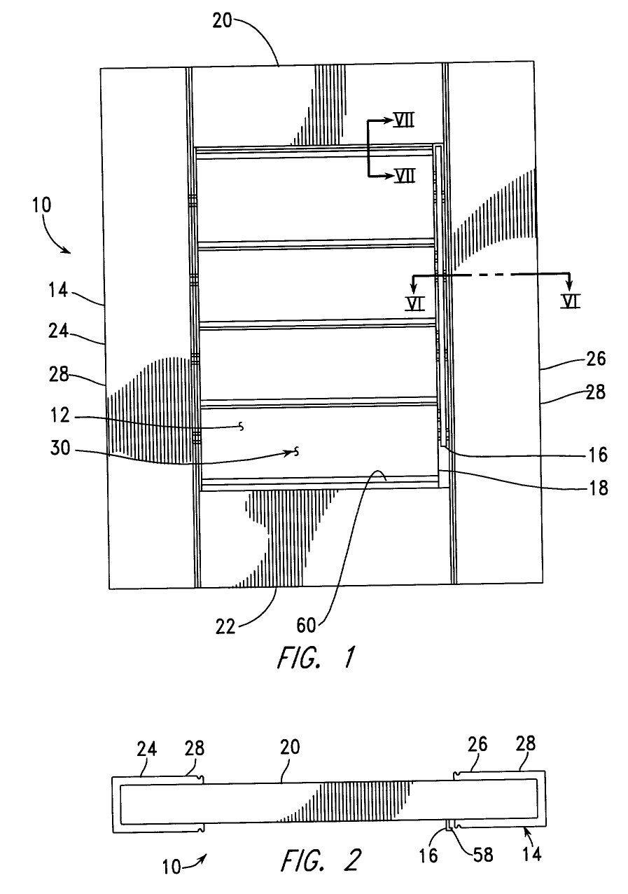

FIG. 1 is a front elevation of a shutter 10 built in accordance with the present invention to include a number of individual louvers 12 pivotally mounted within a frame 14, to be simultaneously pivoted for opening or closing the shutter, by means of a pivot bar 16 extending along a common end 18, such as the right end in the example of the figure, of each of the louvers 12. The frame 14 includes an upper frame member 20, a lower frame member 22, a left frame member 24, and a right frame member 26.

FIG. 2 is a plan view of the shutter 10, particularly showing the upper frame member 20 fitting within a channel-shaped outer portion 28 of both the left frame member 24 and the right frame member 26. These elements 20, 28 are, for example, adhesively attached to one another during the assembly of the shutter 10. The lower frame member 22 is similarly attached within the other ends of the channel-shaped outer portions 28.

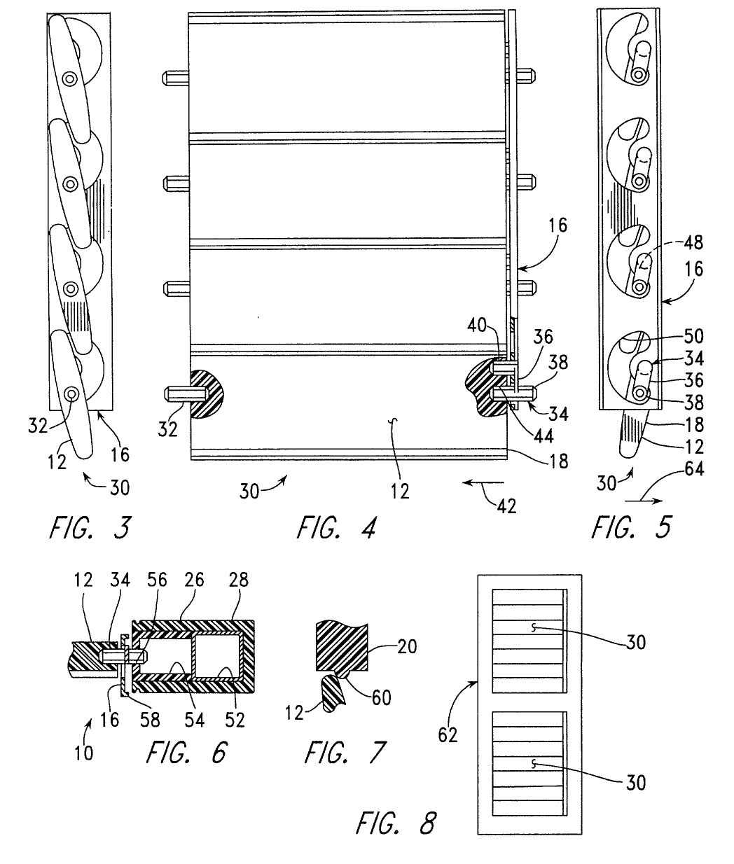

FIGS. 3-5 show a louver assembly 30 forming a portion of the shutter 10, with FIG. 3 being a left elevation thereof, with FIG. 4 being a partly sectional front elevation thereof, and with FIG. 5 being a right elevation thereof. The louver assembly 30 includes a number of louvers 12, each of which includes a pivot axle pin 32 and a pivot drive pin 34. Each pivot drive pin 34 includes a web portion 36, connecting a central pin portion 38 with a crank pin portion 40. The central pin portion 38 extends both longitudinally inward (along the length of the louver 12), in the direction of arrow 42, and longitudinally outward, opposite the direction of arrow 42, from the web portion 36. The crank pin portion 40 extends only inward from the web portion 36. The pivot drive pin 34, being pressed or adhesively attached within a pair of holes 44 within an associated shutter 12, pivotally attaches the shutter 12 to a pivot bar 16 within the louver assembly 30. The central pin portion 38 extends into the associated shutter 12 through a pivot hole 48 within the pivot bar 16, with the pivot hole 48 being loose enough to permit pivoting of the louver 12 on the pivot bar 16 but tight enough to prevent substantial sliding motion between the louver 12 and the pivot bar 16. The crank pin portion 40 extends through a semicircular slot 50 in the pivot bar 16.

With FIG. 4 being considered a front view, the louvers 12 are shown in a fully closed orientation, extending downward toward the front. As the louvers are moved upward in the front, into a horizontal, or fully open orientation, each of the central pin portions 38 moves through a lower portion of an associated semicircular slot 50. Continued pivoting of the louvers in this direction brings them into a fully closed orientation, with the louvers extending upward toward the front.

FIG. 6 is a cross-sectional plan view of the shutter 10, taken as shown by section lines VI-VI in FIG. 1, particularly to show the internal construction of the right frame member 26. This frame member 26 includes the channel-shaped outer portion 28, a metal stiffening tube 52, and a pivot-mounting channel 54. Preferably, the pivot-mounting channel 54 is adhesively attached within the channel-shaped outer portion 28. The metal stiffening tube 52 may also be adhesively attached within the channel-shaped outer portion 28, or it may be allowed to slide within this outer portion 28, to be contained therewithin by the attachment of the upper frame member 20 and the lower frame member 22 to form the shutter 10, as shown in FIGS. 1 and 2. The pivot-mounting channel 54 includes a number of spaced-apart holes 56, through which the central pin portions 36 of the pivot drive pins 34 extend to pivotally mount each louver 12.

The left frame member 26 is similarly constructed to include the channel-shaped outer portion 28, the metal stiffening tube 52, and the pivot-mounting channel 54. Each of the axle pins 32 (shown in FIG. 4) extends through a hole 56 in the pivot-mounting channel 54 of the left frame member 26, so that the louvers 12 are pivotally mounted to extend between the pivot-mounting channels 56 of the right and left frame members 24, 26. With the louvers 12 pivotally mounted in this way, the pivot bar 16 slides with movement of the crank pin portions 40 as the louvers 12 are pivoted.

In accordance with a preferred version of the invention, the distance between the central pin portion 38 and the crank pin portion 40 is the same for each of the pivot drive pins 34, the holes 56 of each of the pin-mounting channels 54 are spaced apart at a common spacing distance along a straight line, and the holes 48 of the pivot bar 16 are spaced apart at the same common spacing distance as the holes 48, also lying along a straight line. These conditions are sufficient to ensure that the pivot points formed by the central pin portions 38 and the crank pin portions 40 associated with any two of the louvers 12 form a parallelogram, and that such a relationship is maintained as the louvers are pivoted, with an associated sliding motion of the pivot bar 16. Therefore, the louvers 12 remain parallel to one another as they are pivoted.

Preferably, the pivot bar 16 includes a pair of flanges 58, which add to the strength and stiffness of the bar 16 and which further serve to hide various mechanical details, such as the semicircular slots 50 and the web portions 36 from view.

FIG. 7 is a fragmentary cross-sectional right elevation of the shutter 10, taken as indicated by section lines VII-VII in FIG. 1, particularly showing a protrusion 60 extending downward from the upper frame member 20 and upward from the lower frame member 22 to enhance the ability of the uppermost and lowermost of the louvers 12 to close the opening within the frame 14.

FIG. 8 is a front elevation of an alternative shutter 62 built in accordance with the present invention to include two louver assemblies 30.

The larger elements within the shutter 10, including the louvers 12, the upper frame member 20, the lower frame member 22, and channel-shaped outer portions 28 are formed, for example, by coextruding a structural foam core material with a solid thermoplastic cap material. The core material is, for example, either a structural ABS foam with a twenty percent wood filler, or a structural PVC foam with a 5.5 density.

Referring again to FIGS. 1 and 5, the present invention has an advantage over the prior art arising from the fact that he pivot bar 16 of the present invention is much wider in the direction of arrow 64 than the pivot bars of the prior art. This additional width allows the pivot bar 16 to be stronger and stiffer, providing for use in small shutter assemblies without special provisions to reduce pivoting friction. Specifically, the pivot bar 16 is larger than the pivot bar of U.S. Pat. No. 4,936,048, because the width of the pivot bar 16 is not limited by a need for the edge of the pivot bar to clear the pivot pins extending from the centers of louvers when the louvers are closed. Additionally, the pivot bar 16 of the present invention blocks most of the gap between the louver ends 18 and the adjacent right frame member 26 without requiring recessed areas within the louvers, as described in U.S. Pat. No. 6,219,970, and thus without placing additional requirements on the shape of the pivot bar.

Furthermore, since the pivot bar 16 of the present invention extends between the louvers 12 and the right frame member 26, instead of within the right frame member 26, as described in U.S. Pat. No. 4,996,793, an enlarged box structure of this frame member is not required.

While the present invention has been described in preferred forms or embodiments with some degree of particularity, it is understood that this description has been given only by way of example, and that numerous changes in the details of fabrication and use, including the combination and rearrangement of parts, may be made without departing from the spirit and scope of the invention.

What is claimed is:

1. A shutter comprising:
a frame including an upper frame member, a lower frame member, and first and second side frame members;
a plurality of first pivot axle pins;
a plurality of second pivot axle pins;
a plurality of louvers, wherein each louver in said plurality of louvers is pivotally mounted to extend between said first and second side frame members by a first pivot axle pin within said plurality of first axle pins, extending between said first side frame member and a first end of said louver, adjacent said first side frame, and by a second pivot axle pin within said plurality of second axle pins, extending between said second side frame member and a second end of said louver, opposite said first end of said louver; and
a pivot bar, including a plurality of slots extending within said pivot bar, wherein said pivot bar extends between said first side frame member and said first end of each said louver, wherein said pivot bar is pivotally mounted to each louver in said plurality of louvers at a crank position offset through a first distance along said first end of said louver from said first pivot axle pin extending between said first side frame member and said first end of said louver, and wherein each first pivot axle pin in said plurality of first pivot axle pins extends through a slot within said plurality of slots.

2. The shutter of claim 1, additionally comprising a plurality of crank pins, wherein
said first pivot axle pins are aligned with one another, being spaced apart by said second distance,
said second pivot axle pins are aligned with one another, being spaced apart by said second distance,
said pivot bar is pivotally mounted to each louver in said plurality of louvers by a crank pin in said plurality of crank pins, and
said crank pins are aligned with one another along said pivot bar, being spaced apart by said second distance.

3. The shutter of claim 2, wherein
each slot within said plurality of slots extends in an arc around a crank pin in said plurality of crank pins, and
each first pivot axle pin in said plurality of pivot axle pins moves within a slot within said plurality of slots as a louver in said plurality of louvers is moved from a closed position with said louver pointing downward to a closed position with said louver pointing upward.

4. The shutter of claim 3, additionally comprising a plurality of pivot pins, wherein each pivot pin in said plurality of pivot pins includes a first pivot axle pin in said plurality of first pivot axle pins, a crank pin in said plurality of crank pins, and a web connecting said first axle pin with said crank pin.

5. The shutter of claim 4, wherein
said first side frame member includes a plurality of first axle pivot holes,
said pivot bar additionally includes a plurality of crank pivot holes,
each first axle pin within said plurality of first axle pins extends from said web through a slot within said plurality of slots for attachment to a louver in said plurality of louvers,
said crank pin extends from said web through a crank pivot hole in said plurality of crank pivot holes for attachment to said louver in said plurality of louvers; and
said first axle pivot pin additionally extends from said web for pivotal attachment in a first axle pivot hole in said plurality of first axle pivot holes.

6. The shutter of claim 4, wherein said pivot bar additionally includes a flange extending along each edge of said flange outside said plurality of slots and said plurality of crank pin holes.
